(19) United States
(12) Patent Application Publication
(10) Pub. No.: US 2026/0283096 A1
(43) Pub. Date: Sep. 24, 2026

(54) MOBILE DEVICE FOR KEEPING LARGE LIVESTOCK

(71) Applicant: Andre PRÖBSTING, Dortmund (DE)

(72) Inventor: Andre PRÖBSTING, Dortmund (DE)

(21) Appl. No.: 19/478,023

(22) PCT Filed: Apr. 22, 2024
(86) PCT No.: PCT/DE2024/100360

§ 371 Date: Oct. 23, 2025

(30) Foreign Application Priority Data
Apr. 24, 2023 (DE) 10 2023 110 441.1

(51) Int. Cl. A01K 1/00

(52) U.S. Cl. CPC A01K 1/0035

(57) ABSTRACT

The invention relates to a mobile device for large livestock, having a base surface with a floor, at least four stable side delimitations, such as side walls, a roof which covers the base surface, a frame, a mobile structure having at least one travelling mechanism which is fastened to the frame, an apparatus for setting in pull or push operation or through self-propulsion, a brake system, wherein the base surface is formed by a functional floor, wherein the functional floor is connected to the frame, or the support structure of the functional floor is designed as a frame, the functional floor can be subdivided into functional areas by means of fixed and/or lockable and mobile dividing devices, in the functional floor a plurality of receptacles for push-in modules are provided, on the functional floor at least one walking surface for animals and personnel is arranged which can also be driven on by machines and vehicles, on the functional floor at least one rest area for animals is configured, a plurality of variable entries and exits suitable for independent access to the functional floor for the animals are configured, at least one entrance for vehicles and at least one access for personal to the functional floor are provided.

The invention relates to a system and to a mobile facility for species-appropriate and sustainable livestock farming in a natural environment. Above all, this relates to the farming of large livestock such as cattle, horses, goats, buffalo, alpacas, bison, camels, pigs, donkeys, llamas, sheep and wild animals. The substantial effect of the invention is the proper and species-appropriate configuration, the equipment, the construction, the supply functions and the utilization task of the mobile facility. In addition to grazing, it provides the animals all year round with everything which cannot be provided by nature, for instance due to vegetation or on account of the parceling of the grazing grounds.

Livestock farming is currently split into intensive and extensive farming forms, which leads in both cases to specific problems.

In the case of the intensive farming form, the animals are predominantly tied to the stalls. There are stalls with and without livestock run. This is an unnatural habitat. As a result, the naturally predisposed behaviors, needs and movement patterns are reduced and suppressed. This restricts the welfare and the health of the animals and leads to negative consequences. There is only occasional grazing in a natural environment. In this farming form, the animals are fed predominantly with forage and concentrated feed which also is planted far from the feeding location with the use of fertilizers and has to be transported.

Transport and fertilizers require a large amount of energy, which leads to a high carbon dioxide (CO₂) accrual. Moreover, the nitrogen fertilizers lead during the metabolization to a large quantity of nitrous oxide (N₂O), and the unphysiological concentrated feed leads in the case of grazers to the accrual of methane (CH₄) which is expelled. CO₂, N₂O and CH₄ are considered to be highly effective accelerators for global warming.

The waste of the animals is highly rich in nutrients and can be applied to fields as natural liquid fertilizers only with difficulty, unless eutrophication of soil and water is accepted; moreover, composting is usually not possible. In the stalls, the pollutants and attracted flies impair the health of the animals. Diseases can spread easily.

The extensive farming form as a rule does not manage without animal collection points, which leads at these points to soil overloading. Furthermore, in the winter months due to the weather and on account of the absence of vegetation, the animals are often accommodated in permanent buildings and stalls which are once again not a natural habitat. In addition, there are farming forms, above all in the case of beef cattle, which can live outside all year round and require supplementary feeding only in low-vegetation phases.

Here, mixed herds with different livestock are also known. Instead of regular feeding, grazing farming predominantly takes place. Here, in the case of mixed herds, the herds can be composed in such a way that the meadow area is grazed depending on the preferences of the animals even in the case of different grasses. This corresponds to the natural behavior of migratory steppe dwellers.

This cultivation form has the great advantage that not only do greenhouse gases scarcely arise, but rather that grazing triggers a root forming reflex in the plants, which leads per year to an absorption of approximately half a ton CO₂ per hectare of meadow area. For this purpose, the grazing has to take place in such a way that corresponding regeneration phases have to be given to the grazed grasses and weeds. If they are too short, the CO₂ storage in the soil does not take place and, if they are too long in contrast, the grasses and weeds flower and cease putting down further roots, with the consequence that likewise less CO₂ is stored as root mass than would be possible.

Grazing management is therefore required which corresponds to the natural migratory behavior of large herds. Although approximately 40% of the farmable areas worldwide are grassland which is suitable for this purpose, this encounters restrictions and obstacles in a world which is parceled and crisscrossed by streets and rails and in which each patch of earth has an owner and is subject to administrative regulations. The solution can only be as follows: The accommodation migrates with the animals; a mobile facility is needed which fulfills all supply functions and all regulations. This should be equipped and constructed in a proper and species-appropriate manner, should be capable of being driven on by light agricultural machines and should be of such stable configuration that even heavy and powerful animals are accommodated safely.

Some attempted solutions have already been described in the prior art. For instance, EP 1 002 461 A1 describes a mobile pigpen with a slatted floor which is equipped with a sludge sump and, furthermore, with side walls, a roof and ventilation devices with a controlled feed and discharge of air. Stalls and feeding facilities can also be provided. In order to move the mobile stall, dismantling is required; it cannot be moved or displaced as an entire stall.

FR 2 496 401 describes a small mobile stall which serves, above all, to accommodate horses. Its construction corresponds to a roadworthy horse trailer for transporting horses which additionally has facilities of a horse stall such as, for example, a feed station. The stall cannot be driven on by agricultural machines or units.

WO 2000 059 296 A1 describes a movable poultry house with fold-out side walls and with a scratch floor with a scratch pan. This prevents the animals from picking up dirt outside the poultry house and dragging it into the poultry house and therefore contaminating the eggs. Here, the scratch pan is arranged so closely above the floor that no hens can pass below the scratch pan. After the side walls and lateral scratch floors are folded in, the poultry house can be moved on public roads. While they are at a standstill, a plurality of poultry houses of this type can be connected to one another longitudinally in the manner of a train, in order to form a large poultry house, which affords economic advantages. The house itself cannot be driven on by agricultural machines, however.

DE 20 2017 007 021 U1 describes a vaulted free-range farming means for dairy cows with stall systems and tethering systems, as well as a milking device. Here, the animals have free access to eat and be milked at the same time. An automated milking device is moved from above onto the animals in order to milk on elevated rails, but the entire facility for free-range farming cannot be moved in its entirety. Furthermore, a habitation region for dairy cattle and a farming facility are provided. A farming robot can be used to dry or to otherwise treat the soil, for instance for cleaning, for soil removal, for composting or for the introduction of oxygen. Animals and units are monitored by cameras.

DE 20 2013 007 369 U1 describes a mobile pasture hut on a trailer with fold-out side walls, a roof and swing doors. In this way, a shelter for a plurality of animals is achieved with low expenditure, wherein the erection and dismantling work can be carried out in a modest and rapid way, since all required components are attached fixedly to the trailer. The pasture hut does not have its own floor. If the pasture hut is to be moved, tired wheels with plug-in axles are mounted on the frame after the stall is raised. The pasture hut can also be used as a tractor unit. During the movement, the cattle travel in the closed trailer behind the tractor which pulls the trailer. The pasture hut can also be provided with a floor and, as a result, can be used as a cattle transporter. It cannot be driven on by machines or vehicles, however.

US 2019/0110430 A1 describes a mobile shelter for an animal home facility for poultry and rabbits, in the case of which the floor is free and a frame with a roof and feeding facilities can be moved with a chassis comprising transport wheels in a plurality of directions in a way which is programmable, remote controllable or GPS-controlled. A flexible, peripheral apron in the lower part of the side frame can compensate for unevennesses of the underlying surface here. The upper parts of the side walls can be folded out upward and also serve as a sun protection means; the openings are secured by wire mesh. It is not provided firstly that the animals can leave the apparatus, and secondly it is not prevented that animals can dig their way out or predators can dig their way in.

EP 2 702 866 B1 describes a mobile stall for accommodating poultry, calves or pigs, which can be moved on runners on an open area and which has a base frame, walls standing on top of the latter, and a roof. The mobile stall does not have a floor, but can have a grate, in order that the animals do not come into contact with the feces. The mobile stall has to be moved by a tractor unit as soon as the soil is contaminated with the maximum acceptable quantity of feces. The animals can enter and exit the stall as desired. The mobile stall cannot be driven on by machines or vehicles.

DE 20 2005 005 236 U1 describes a mobile pasture hut comprising modular side walls and a roof, which are connected by a frame. If the pasture hut is to be moved from one location to the other, the side wall modules and the roof are removed individually, and the transport of the modules and the frame takes place in the dismantled state. The mobile pasture hut is assembled again at the destination; the pasture hut does not have a floor.

DE 83 05 464 U1 describes a movable animal stall for the temporary accommodation of animals such as horses or wild animals and also for storing animal feed, riding equipment and the like, wherein the movable stall can be transported away at any time by coupling it to a tractor unit.

There is also relevant prior art for the related areas within the mobile facility, with regard to modular construction, for example from the technology in respect of animal transport. For instance, EP 654 396 B1 describes floor elements which provide safe grip to cloven hooved animals even in the case of soiling. These floor elements have H-shaped embossments as profiling, are replaceable and are possibly easy to clean.

The systems described are either small or suitable only for small animal husbandry, or they are complex and very heavy, which considerably restricts their mobility. In the case of the mobility, the great weight has to be taken into consideration, above all; while small mobile stalls usually weigh below a weight of a few tons including the animals located therein, larger units for livestock can also weigh substantially more on account of the required stability. This is even more so the case if mobile facilities of this type are to be capable of being driven on by machines and vehicles. In the case of the movement by way of heavy working machines, very high forces act here on the floor, which might firstly damage it but secondly also makes the movement as an entire unit considerably more difficult.

It is therefore the object of the invention to solve the described dilemma and to provide a solution which has the advantages of intensive and extensive farming and avoids the respective disadvantages, but at the same time is economical and ecological.

The invention achieves the object by way of a mobile facility for livestock, having
at least one base surface with a floor,
at least four stable lateral boundaries such as, for example, side walls,
a roof which covers at least the entire base surface,
a frame,
at least one chassis with at least one bogie which is fastened to the frame,
at least one apparatus for initiating towing operation and/or propulsion operation or by self-propelling operation or as partial drive or as auxiliary drive,
a brake system,
   wherein
the base surface is formed by a functional floor,
wherein the functional floor is connected to the frame, or the supporting structure of the functional floor is configured as a frame,
the functional floor can be divided into functional regions by way of fixed and/or lockable and mobile separating devices,
a multiplicity of receptacles for plug-in modules are provided in the functional floor,
at least one walking surface for animals and staff, which can also be driven on by machines and vehicles, is arranged on the functional floor,
at least one rest surface for animals is configured on the functional floor,
a plurality of variable entries and exits with suitability for unassisted access are configured on the functional floor for the animals,
at least one entranceway for vehicles and at least one entrance for staff is provided on the functional floor.

Here, the division of the functional regions for the animals takes place in a proper and species-appropriate manner for the respective animals, and can be adapted correspondingly if animal species are changed.

With regard to the receptacles for plug-in modules, a multiplicity is understood to mean a number between two and a thousand, in order to make a variable and modular construction possible. The at least one entranceway for vehicles and the at least one entrance for staff to the functional floor can also be used here in a combined manner by the animals.

The functional floor does not lie directly on the ground here, which protects the pasture ground but, above all, the turf. Only individual elements lie in a temporally limited manner on the pasture ground or the turf. The functional floor is dimensionally stable and is supported by means of at least one bogie and/or the supporting elements. It can be assembled from an upper functional floor and a lower functional floor. The functional regions are formed on the functional floor; these are animal-specific lying zones, resting zones, running surfaces, moving areas, eating regions, trough regions, care zones, common spaces, medical regions, birth regions and baby regions, milking region, shearing region and further regions adapted to best possible welfare, health, naturally predisposed behavior, requirements and distance and evasion possibilities for this purpose for hierarchical structures of the animals and their utilization task; they are constructed, configured and equipped in a proper and species-appropriate manner for individual, group and herd farming. As a result of the modular design, different requirements can be met by reinserting the separating devices in the case of the stock changing. In this way, there is also sufficient possible separation for the animals in the case of disease, births, in their treatment and baby region, as individual and group bays or stalls with fixed side walls. As a result of the variable separations in the form of plug-in walls or other interior devices, the approach can be flexible.

Refinements relate to the plug-in walls. They have fitting means and releasable locking means, by way of which they are connected to the functional floor fixedly but releasably. Here, the plug-in walls can comprise grilles, grates or solid walls with visual protection or rods, fence elements, boards or further elements; their height can be different; devices for the functional regions can be fastened to them. The same applies to the other separating devices which are of comparable construction. For this purpose, different swing, folding, sliding, swiveling and telescopic systems and further systems also comprising hollow profiles are provided.

Further refinements relate to the functional floor. For certain functional regions, it can be formed on its upper side from plug-in elements of an upper floor which likewise fit into the plug-in receptacles of the functional floor and are therefore connected releasably. As a result of occasional removal, the plug-in elements of the upper floor can be cleaned and disinfected if this should be necessary for hygienic reasons, for example after a disease outbreak, or for maintenance or repair of components and systems situated below them. As a result of the plug-in elements of the upper floor and the plug-in walls, the functional regions are of application-related design and are separated spatially if necessary in an animal-specific and herd-specific manner.

It is provided in further refinements that
at least one hoisting/lifting/lowering apparatus is provided which is combined with the bogie or is separate therefrom and by way of which the mobile facility can be lifted or lowered or stablilzed,
a multiplicity of fixed and/or height-adjustable supporting elements are provided, by way of which unevennesses below the entire mobile facility can be adjusted in terms of height, stabilized and oriented.

In a further refinement, the supporting structure of the functional floor is configured as a framework, wherein the framework fulfills the load-bearing function and is torsionally rigid. It is configured from flat, open and/or closed profiles. Solid profiles are also possible. The supporting elements and plug-in receptacles are fastened to the supporting structure.

The fixedly connected and plug-in upper floor is therefore situated on the carrier construction; its design and equipment take place in each case in a manner which is species-appropriate, slip-proof, health-promoting and corresponds to the social behavior of the animals, depending on the animal species. These also include further devices such as a milking system and milking robot, individual stalls, lying and recovery regions, feeding facility, active or activity zones, a region for collecting excretions, riding, cleaning or care region, and further regions. For mixed herds, the upper floor can be configured with different regions for different animal species.

The functional floor receives the excretions of the animals or separates them, for example using straw as a manure surface or deep litter region. It prevents the feces from contaminating and overfertilizing the pasture ground situated below, and the vegetation from then also dying as a result of trampling damage. In one refinement, the functional floor therefore has a fixed, sufficiently closed upper floor and impermeable lower floor at least in sections.

For manure removal, the upper floor can correspondingly be driven on by earthmovers, telescopic handlers or tractors on defined paths. For manure removal, a rolling belt floor, a slide system or the like can optionally also be installed. If it promotes the health of the animals, the upper floor can also be fitted with rubber mats or water mats or the like. Different bedding types such as sawdust and pellets are also possible.

The fundamental construction of the functional floor and, connected to this, of the frame, the chassis and the bogie corresponds here to customary modular construction designs of vehicle manufacturing, automotive technology, agricultural technology, stall construction, lightweight design, framework and grid constructions, with the design difference that the mobile facility is in transit only slowly when it is moved. The design therefore predominantly takes place according to static aspects and not according to dynamic aspects with regard to the forces to be absorbed. Here, the components of the functional floor are to be of corrosion-resistant and long-lasting construction.

The complex functional floor of the mobile facility provides all and complete functional regions to the animals for living out all of their natural requirements in a species-appropriate form, species-appropriate scope and a species-appropriate way. In comparison with the above-described prior art, room and space is provided for the natural behaviors: livestock such as, for example, cattle are animals which require a distance from one another of 0.5 to 5 m. They are herd/group animals with clear hierarchical structures. The available space and resources have to be sufficient to provide evasion possibilities for lower-ranking animals with respect to higher-ranking animals. Separation possibilities for individual animals in the case of diseases or for calving in calving bays are also required. For dairy cattle, the space requirement of the mobile facility and the grazing are shown in the following text by way of example for dimensioning purposes. In stationary resting pens/upright pens, the space requirement per head of dairy cattle is from 4 to 6 m². In the extensive farming form, the cattle density is one to two animals per hectare, and in the intensive farming form, five or more animals are also farmed per hectare. For optimized grazing management, a value in between is generally optimum due to the natural vegetation of the pasture and the regeneration requirement, above all when additional fertilization of the grazing area is dispensed with. An optimized grazing management of this type also leads to the ground storing large quantities of CO₂ as humic acids; approximately 0.5 tons are removed from the atmosphere per year and hectare.

The functional floor also has the task of collecting the excretions of the animals. During watering, resting, movement and when feeding, in particular, the excretions remain on the functional floor and are not fed directly to the pasture ground, as is otherwise the case during grazing. As a result, the nutritional balance of the pasture decreases per se, with the result that a higher cattle density is possible. A precondition to this is that the collected feces are either composted or scattered on a different area or a different piece of pasture than the area on which the animals are situated. Therefore, a higher cattle density is possible even under ecological aspects; in the case of 2 to 3 livestock per hectare on a grazing area of 13 to 19.5 hectares, a cattle stock of 39 livestock, for example dairy cows, results. It is also possible here to change between two or more meadows which lie next to one another.

An overall area of 160 to 240 m² results therefrom for the size of a functional floor. A further 60 m² are required for additional devices such as chassis and milking device. A mobile facility of this type can therefore be constructed, for example, with external diameters of 15×15 m to 15×20 m. Here, the weight of the inhabitants is approximately 26 tons; the construction is approximately equally heavy and corresponds to the requirements of the underlying surface, for instance on account of gradients, weather, etc. Instead of one large functional floor, a multiplicity of smaller units can be coupled to one another for a large mobile facility, depending on the local conditions with regard to the regular movement.

While movable stalls for small animal husbandry, for instance for poultry and rabbits, have long since become prior art, mobile stalls for livestock have failed up to now due to the weight and dimensions of the constructions which have to be of extremely solid and torsionally resistant design on account of the masses and the forces of the livestock. This rigidity with at the same time a lightweight construction is produced by the functional floor.

It can be provided by way of example that the load-bearing frame and lower floor are constructed from thin-walled, closed hollow profiles which are layered above one another crosswise in at least two layers. They are preferably connected to one another by way of elastic molded parts. These do not reduce the rigidity, but damp vibrations; in this way, a sprung floor which is gentle on the joints of the animals is produced. If the two layers are constructed from square rectangular profiles comprising galvanized steel tubes and if every second row is left free, a weight of approximately 18 tons for 220 m² results in the case of tubes with an edge length of 100×100 mm and a wall thickness of 3 mm or, in the case of an edge length of 80 mm and a wall thickness of 2 mm, a weight of approximately 12 tons results. It goes without saying that different hollow profiles and different materials can also be used; the spacings of the hollow tubes from one another can also be selected to be greater or smaller. I-beams and/or grid constructions can be used instead of the hollow profiles.

For example, the supply and removal lines run between the rods, profiles or within the hollow profiles; they can possibly be cleaned satisfactorily using pigging technology. The upper floor is designed and fixed above the layers of the profiles, for example made from plywood or reinforced concrete which is reinforced where vehicles such as, for example, dung scrapers are to drive. Where the animals preferably urinate, slatted floors or gutters with drains and cover grates can be provided, wherein they are connected to the removal lines and collecting apparatuses, with the result that the areas below the functional floor remain uncontaminated. It is also prevented in this way that ammonia-containing aerosols arise excessively.

Further refinements relate to the bogies which are given special attention on account of the great weights. Here, depending on the size of the mobile facility and the local erection conditions, a selection can be made between three fundamental alternatives, wherein in each case two can also be combined with one another; furthermore, the bogies can also be of split configuration. A common feature of them is that a height adjustment means and height adaptation means are provided, in order that unevennesses of the terrain can be compensated for. At least one bogie is necessary.

The bogie is connected to the chassis, the frame and/or supporting structure of the functional floor with a track running gear, a tire running gear or a rail running gear. This at least one bogie is arranged between the frame/chassis and the functional floor or below the upper floor or outside the area of the functional floor. Here, at least one hitch apparatus, suitable for moving, for vehicles or at least one auxiliary drive or partial drive for assisting a tractor unit or at least one apparatus suitable for moving by hoisting winches or hydraulics or at least one drive suitable for self-propelled driving is provided on the frame. A runner system is also possible.

In order to move a mobile facility, an apparatus for steering is provided on at least one of the sides; this can be a drawbar with a towing apparatus or towing cable. The mobile facility can then be moved slowly by way of an external tractor unit or a cable winch without disassembly. Relatively large mobile facilities are equipped with at least one self-steering system and/or positive steering system on the bogies.

Here, the tracks correspond to those which are used in the case of crawler excavators or combine harvesters, and the wheels correspond to those for heavy road vehicles or LOF (Land Or Forestry) vehicles; depending on requirements made of the steering capability, they can be attached to self-steering axles. The rails correspond to those of trams. For the mobile facility, in each case at least two, but better four or more tracks or wheels of this type are then required. They can also be installed in a double manner and/or as a tandem. The tracks or wheels preferably move on dry pasture ground or paved traffic lanes or roads. The soil compaction on pastures without a firm underlying surface is dependent on wheel load, contact area and pressure. This produces the required number of wheels or tracks. It is also possible to pave the underlying surface with ground protection/road plates. Higher axle loads can also be selected in the case of the use of rails which are connected fixedly to the ground.

The mobile facility is integrated on a pasture area of sufficient dimensions, wherein the pasture serves as a natural habitat. Here, the pasture may be covered with trees, hedgerows, watercourses, ditches, cliffs, etc., wherein inhomogeneity is to be preferred, in order that the animals can intuitively utilize the natural environment, for instance by lying in the grass or seeking shelter. The natural ecological system is intended to be able to be produced between the livestock, plants and insects. Pasture grazing can also be implemented, which alternates between different portions of the pasture area, in order that the vegetation can regenerate between the grazing processes. Since a stimulus for root development is exerted in this way, which leads to increased humus formation from carbon dioxide, half a ton of carbon dioxide can be captured from the atmosphere as humus store per year and hectare in this way.

The mobile facility completes the ecological system if the natural environment reaches its limits due to weather or due to vegetation. The proposed mobile facility can be utilized by the livestock in an independent and instinctive manner, from their own initiative. For this reason, free movement space, species-appropriate resting and recovery zones, weather protection, troughs, feeding region and protection against predators and much more are offered in the facility. The livestock can enter and exit the facility as desired. A detection system for wolves or other predators can be configured or integrated into an animal monitoring system.

The mobile facility is moved regularly, in order to avoid meadow damage and local overloading of the soil and the turf. This movement can take place either continuously or discontinuously; it preferably takes place discontinuously. It can optionally be monitored and controlled by GPS or comparable systems.

The continuous movement takes place in a railborne manner, preferably on rails which are embedded on the meadow. The transport of large weights via rails is known prior art and proven concepts of rail vehicles can be employed in the construction. The speed is very slow and, in the normal case, is between 5 and 50 cm/h. In the ideal case, it is a stall width every three days. For this reason, no great drive power is required despite the great masses to be moved, but rather merely a step-up gear unit with a considerable transmission ratio. The drive preferably takes place electrically and can take place in a solar-operated manner, that is to say, for example, can also be interrupted at night.

Since the movement takes place very slowly and uniformly, the livestock can remain in the facility or can enter and exit during the movement. Sensors merely have to ensure that the rails are free in the movement direction. Instead of rails, paved paths can also be used; in this case, the drive takes place via a track running gear or via wheels. It is disadvantageous here that a higher driving resistance is to be overcome, which offsets the advantage of not having to lay rails. The track drive and wheels are situated between the supporting structure of the frame and between or below the upper floor; it is also possible for them to be provided to the side of the base area.

The discontinuous movement likewise takes place in a railborne manner if possible, but it is problematic to move the facility solely by means of a tractor unit, since this might damage the ground on the meadow if there is no paved path. Instead, it is appropriate for the facility to be provided with an additional wheel or track drive, as a result of which the tractor unit is assisted, or to be pulled from a distance by means of a tow rope until it has reached the destination. Some of the livestock have to leave the facility in this time and it has to be ensured that they do not disrupt the process. The traction forces and the required energy can be applied here by a hoisting winch, motors or pumps which are operated at the power take-off shaft or by the hydraulics of a tractor.

If the facility cannot be driven over flat, even terrain, the facility is equipped with a steering apparatus in the manner of a drawbar, on which the tow rope or the tractor unit acts. The facility can then be turned or repositioned by way of a tractor. Relatively large mobile facilities are equipped with at least one self-steering system and/or positive steering system on the bogies.

It is provided in one refinement that the bogie is height-adjustable, just like the entire mobile facility. As a result, it is possible to lower the mobile facility, and to mount it on supporting elements for stabilization purposes if the ground lying below it is not impaired as a result, and to lift it if unevennesses of the terrain are to be compensated for. The height adjustment can take place, for example, mechanically as a cable winch, hydraulically by means of cylinders, or can be carried out electrically by a spindle drive. Pneumatic bellows can also be provided as supporting elements. The supporting elements are preferably arranged in the region of the intersections of the supporting structure of the functional floor.

If the movement including the raising and lowering takes place discontinuously within the context of self-propelled advancing, it can be coupled to the propulsion machine. Only low power outputs are also required here despite the high weight because in each case raising has to take place by only a few centimeters per minute. The electrical energy required for this purpose can be generated using solar.

It is provided in further refinements that longitudinal and transverse joints which can be locked on the frame are provided as height compensation means, since the movement can require them depending on the terrain and the distances, in order for it to be possible to overcome, for example, dips or small elevations. The longitudinal and transverse joints can be configured here as single or double rotary joints.

If public roads have to be used, the frame, the functional floor and the superstructure can be of collapsible, foldable, splitable or telescopic configuration by means of joints, in such a way that it can be collapsed or separated into modules to fit the road width, wherein the releasable modular connections comprise matching profiles which can be pushed in and out. This collapsibility or divisibility into modules can also be useful if relatively great distances are to be covered between the manufacture site and the erection site.

It is provided in a further refinement that the mobile facility is combined in a modular manner behind one another or next to one another, that is to say the individual modules are designed in a splitable manner in such a way that they can be transported in a roadworthy manner or can be assembled behind one another like wagons of trains and can be pulled over great open spaces.

Further refinements relate to equipment. This relates to
active, eating, playing, care and activity zones,
medical, birth and baby region,
individual and communal regions,
bedding regions for straw, pellets and sawdust or the like,
a waste receiving and collecting point,
a wastewater collecting apparatus with a urine and dung collecting container or tank,
mechanical or automated manure removal of the manure surface and bedding regions,
the water and fodder supply, for instance by storage capacities, stocks, or by lines and/or hoses which can be connected separately to supply lines, or at/by supply points or supply carriages,
a milking device, shearing facility, riding, cleaning and care facility,
a solar roof for the power supply of operational devices,
a climate control system including heating and cooling with insulated floor, wall and roof elements such as, for example, panels,
a draft-free ventilation system,
an exhaust air filter for pollutants,
a rainwater retention and collection system for providing cleaning water,
a catching apparatus for animals,
space for office, lounge, cheese production, butchery, meat processing,
devices for cleaning, maintenance, repair and disinfection,
protective devices against predators,
protection against sunlight, wind and drafts, rain and snow,
insect protection,
adequate daylight and lighting.

For animal species which also overcome relatively great height differences in nature such as, for example, goats and certain cattle species, double-decker constructions or climbing opportunities and galleries can also be provided.

In one refinement, at least one feeding device is provided above the upper floor; advantageously there are a plurality of separate feeding devices. They should be permanently accessible from the inside for the animals, possibly also from the outside. The filling can take place in a mechanical or automated manner from the inside and outside. They are to be protected against weather conditions and against predators.

In a further refinement, a milking device is also provided above the upper floor. Both can also be connected to one another in a known way such that the dairy cattle can eat during milking if the mobile facility is used for the dairy industry. Otherwise, the livestock preferably makes use of the meadow for the intake of food.

In further refinements, a solar system and a rainwater retention and collection system are provided on the roof, which solar system generates power for consumers of electrical energy, and which rainwater retention and collection system provides cleaning water for the mobile facility.

In a further refinement, a ventilation system is provided, the exhaust means of which provides separation and storage for methane. In the case of approximately 40 cattle, up to 10 m³ of methane are to be anticipated if the cattle are in the stall for the whole day. Depending on the feed, the quantity of methane can also be lower, above all when the cattle stay outdoors and eat only natural and species-appropriate fodder. In one refinement, a milking device is also provided which can be actuated by dairy cattle. The milking device has a signal device, by way of which milking staff are informed, in order that the milking operation can be initiated and subsequently ended; as an alternative, the milking operation can also be carried out by an automatic milking robot.

Not only the interior facilities but also the side walls are a dimensionally stable boundary for the animals and protect them against weather conditions and predators. Different open or closed embodiments are provided such as solid constructions with wooden boards, concrete slabs, corrugated metal sheets, panels, mesh or tarpaulins at the top, and also weather-resistant side walls comprising mesh or tarpaulins with or without folding or rolling function including a dimensionally stable boundary comprising steel, wood, aluminum or plastic are provided for the animals. For example, rods which can be plugged in or extended are also used.

Different embodiments such as a pitched roof, a shed roof, a pent roof, a lean-to roof, a gas station roof, overhangs can be provided for the roof, and as far as possible should be used as a green roof, a solar roof, etc., or simply with tarpaulins for collecting rainwater. At least a majority of the base area should be covered.

All the components are of course not to be undersized or oversized in terms of strength according to externally and internally acting forces, loads, influences, etc., and are provided with a long-lasting protective coating, for example exhibit corrosion protection and durability over a plurality of decades. Materials and drive and transmission means which can be used are known technology, for instance steel, wood, concrete, rubber, plastic, fibrous materials, mechanical, hydraulic, electric, pneumatic.

For movement purposes, a wet and unconsolidated meadow surface/ground is to be consolidated, in order to avoid meadow/pasture damage, for instance by means of bark mulch, gravel, stones, tar, concrete, rail. Without consolidation of the underlying surface, an adequate or sufficiently large contact area of the tires and/or the track running gears is to be taken into consideration, in order that the ground and the turf are not damaged and excessively compressed. Corresponding ground protection/road plates can also be used. The invention affords the following advantages:
Species-appropriate and sustainable farming in a natural environment without restrictions for animal welfare and nature conservation as in the conventional intensive or extensive farming forms.
Healthy and sustainable animal foodstuffs, products, produce.
Best possible health and maximum welfare for happy animals.
Maximum support for the immune system and the social behavior of the animals.
Avoidance of diseases, injuries, infections and the use of medications, pharmaceutical products and veterinary treatments.
Pronounced reduction of methane emissions on account of species-appropriate and natural farming
Pronounced reduction of carbon dioxide emissions as a result of reduction of fodder crop cultivation including harvesting by way of natural renewal of the pasture area and grazing of the animals. Large quantities of CO₂ are captured in the pasture ground in the process.
Restoration of the soil with humus formation and conservation of microorganisms, insects, birds, etc.
Restoration of the water table by increased water retention and storage capability of the ground and possibly rainwater recovery and prevention of drought by dispensing with soil-compacting or soil-processing cultivation and promoting the humus layer formation.
Solar energy generation.
Improved plant health and soil fertility.
Storage and delivery of the plant nutrients.
Increased soil stability and erosion protection.

The invention will be explained in greater detail on the basis of design sketches, wherein the invention is not restricted to these illustrations, however. In the figures:

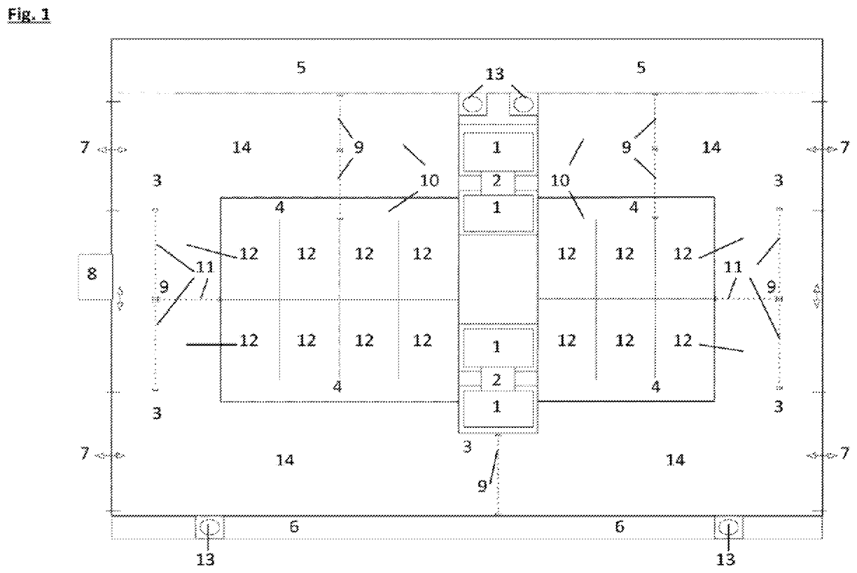

FIG. 1 shows a floor plan of a mobile facility for dairy cattle,

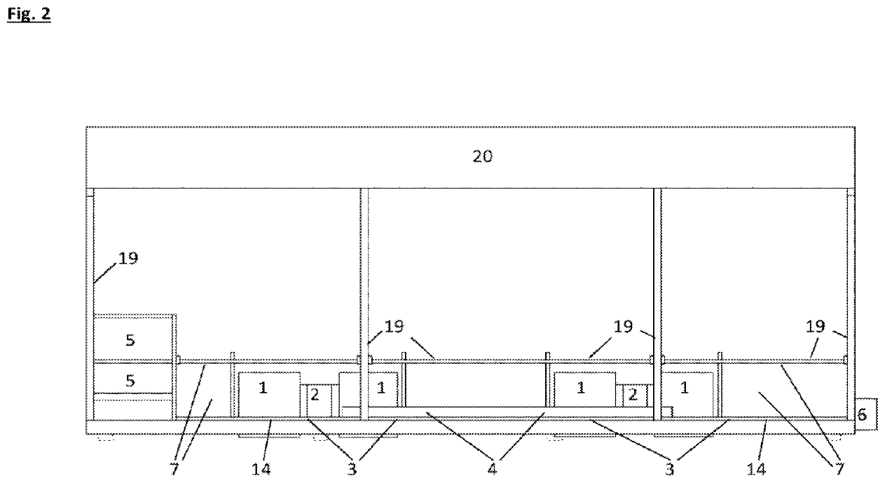

FIG. 2 shows the front view,

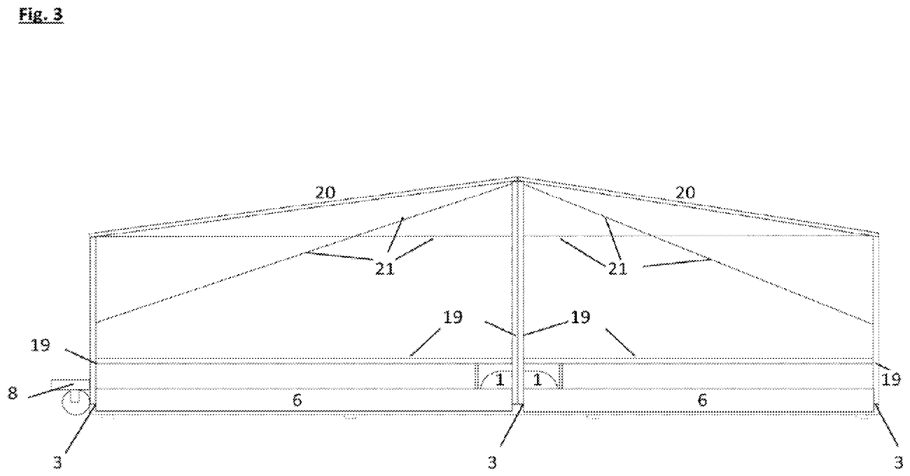

FIG. 3 shows the side view,

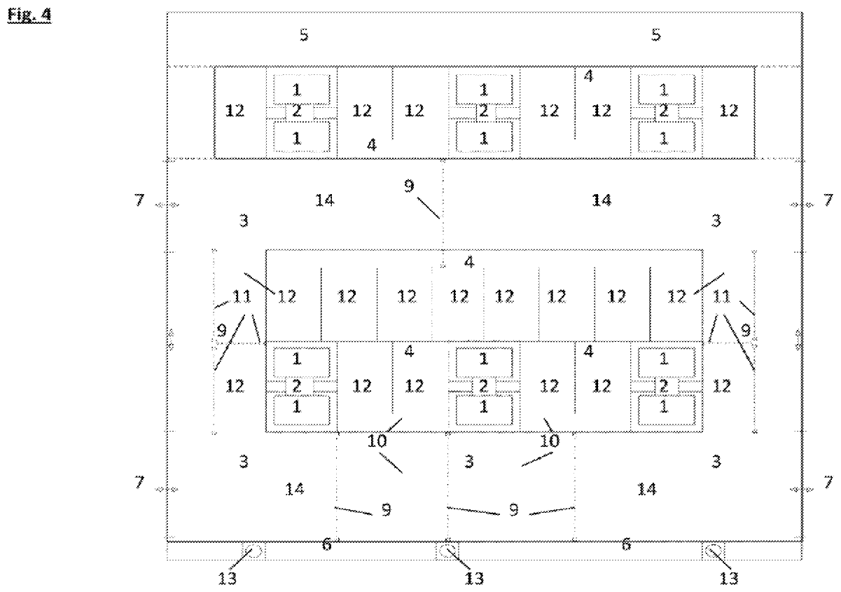

FIG. 4 shows a floor plan of a larger mobile facility for dairy cattle,

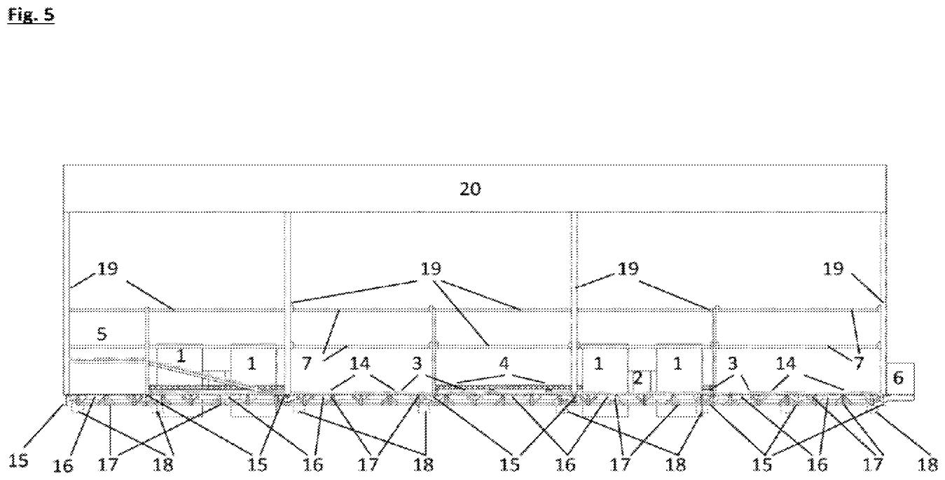

FIG. 5 shows the front view with a detailed functional floor construction,

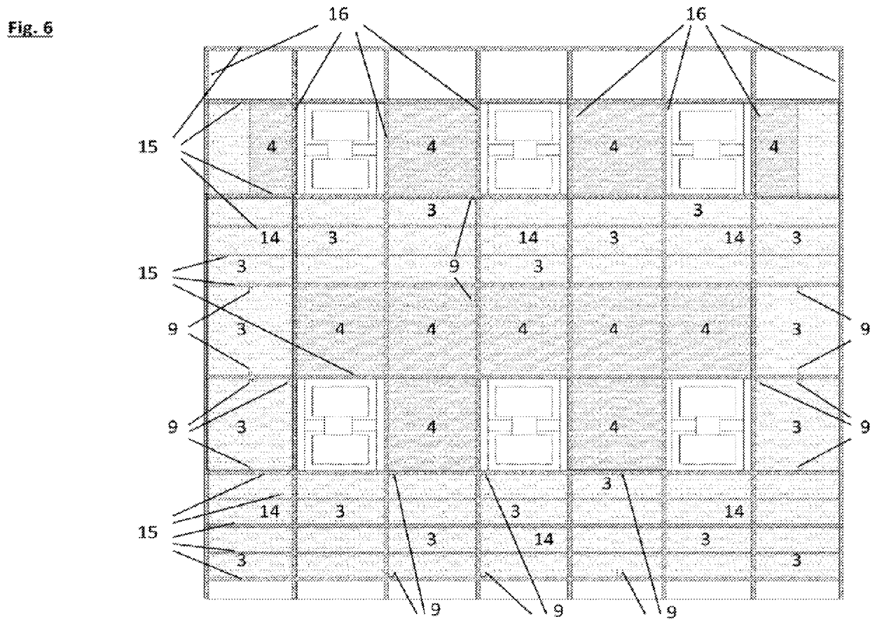

FIG. 6 shows a floor plan of the supporting structure and upper floor of the functional floor,

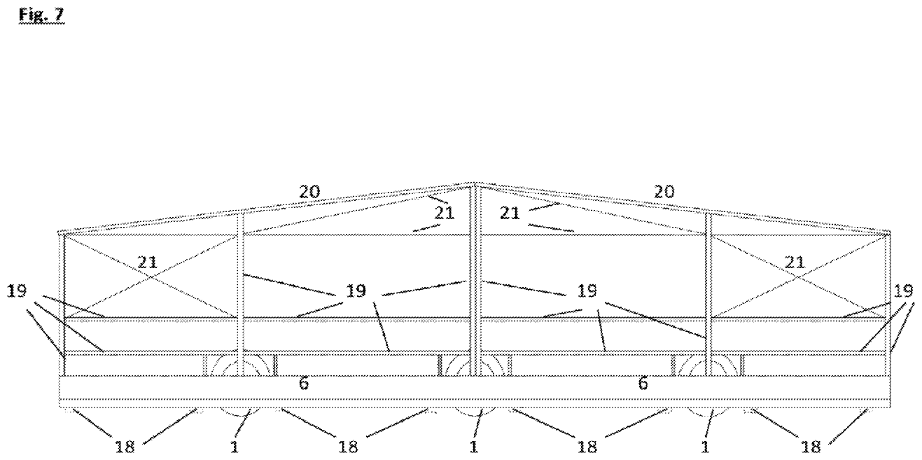

FIG. 7 shows the side view of the mobile facility,

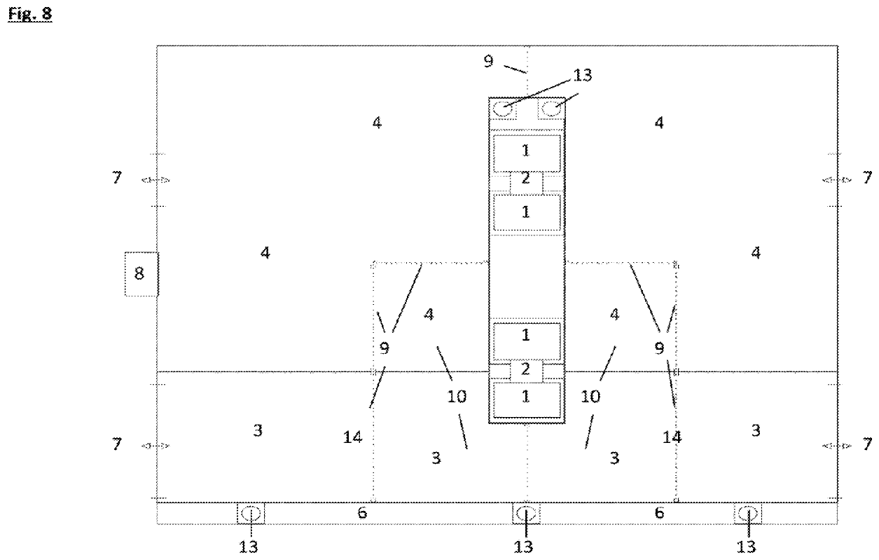

FIG. 8 shows a floor plan of a mobile facility for cattle,

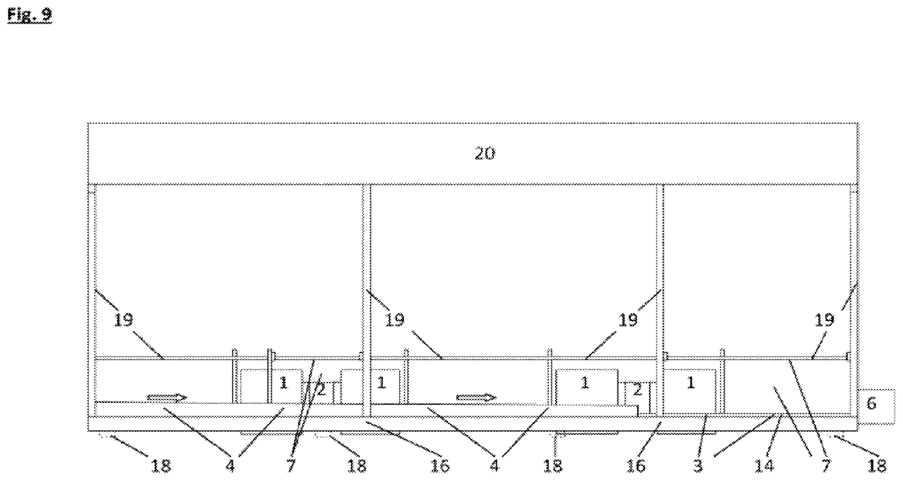

FIG. 9 shows the front view,

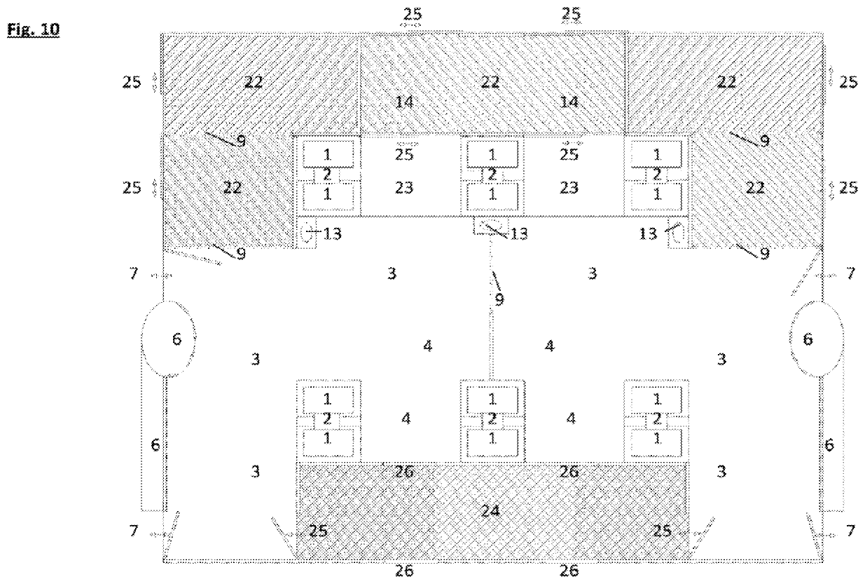

FIG. 10 shows a floor plan of a mobile facility for horses,

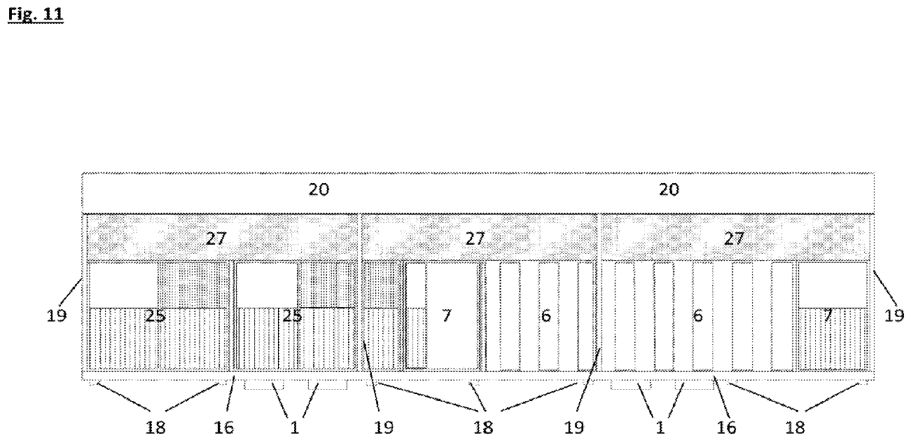

FIG. 11 shows the front view,

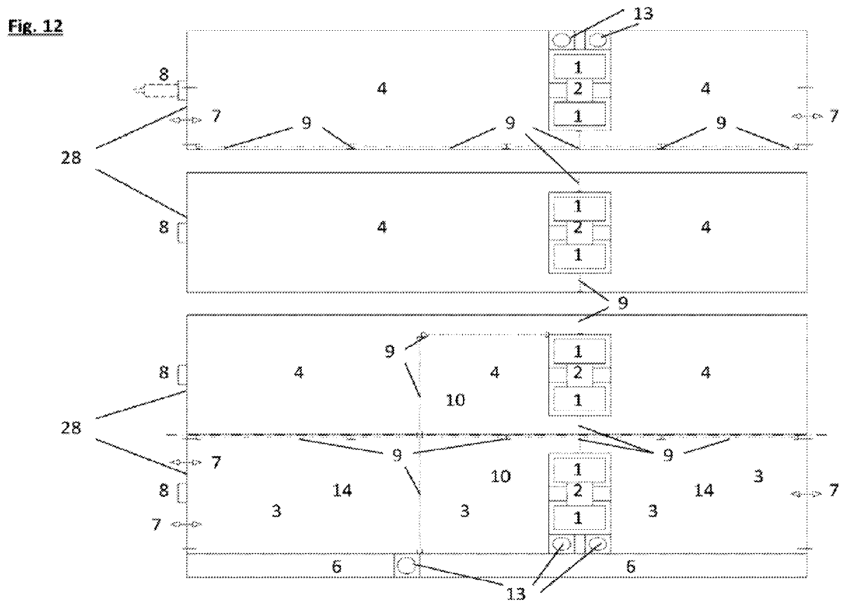

FIG. 12 shows a floor plan comprising four detachable facility modules,

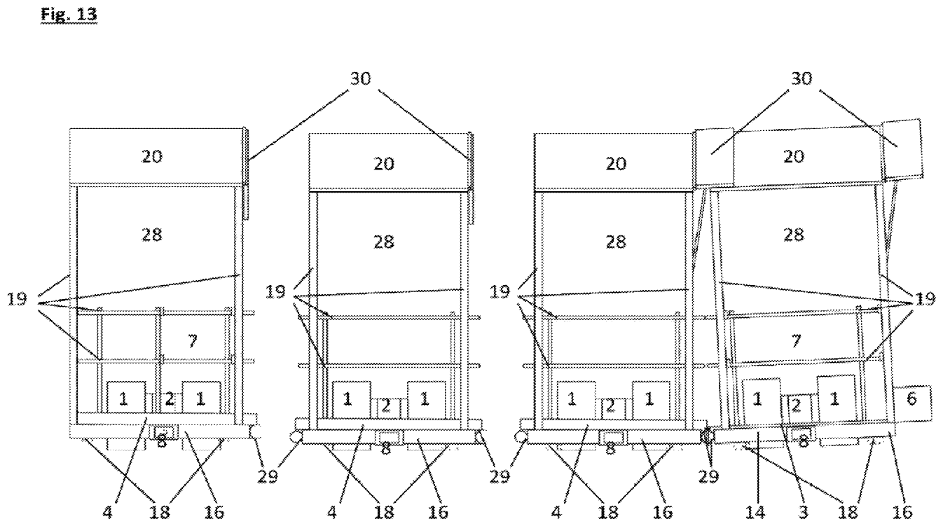

FIG. 13 shows a front view comprising four detachable facility modules, and

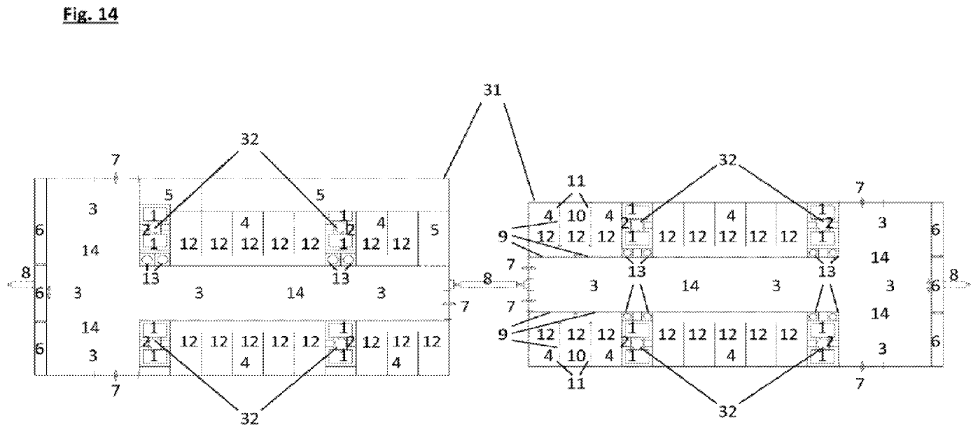

FIG. 14 shows a floor plan of larger facility combinations.

FIG. 1 shows a floor plan of the mobile facility for dairy cattle with four running gears 1, a height-adjustable bogie 2, walking areas 3, recovery areas 4, a milking device 5, feeding region 6, a plurality of entries and exits 7, and the hitch apparatus 8 for a tractor unit. The walking areas 3 can be driven on here and, in contrast, the recovery areas 4 which also serve as a rest area cannot. The separation regions 10 are delimited as required by way of the mobile separating devices 9 for variable functional regions, and likewise by way of the plug-in boards 11. The resting pens 12 are also situated on the recovery area 4; furthermore, the troughs 13 are shown.

During the times in which the mobile facility is at a standstill, the running gears 1 are relieved and lie on the meadow ground to a limited extent for stabilization purposes. Machines and light vehicles can then also be used on the floor reinforcements 14. If the entire mobile facility is to be moved, the height-adjustable bogie 2 lowers the running gears 1, and the entire mobile facility is slightly raised.

FIG. 2 shows the front view of the mobile facility from the view of the hitch apparatus, wherein the front with the door openings is not shown. Beyond what has already been described in FIG. 1, the lateral boundaries 19 and the roof 20 are shown. The load-bearing profiles are mounted fixedly.

FIG. 3 shows the side view of the mobile facility; the wide feeding device 6 is arranged in the foreground. The running gears are relieved as in FIG. 1; the other objects also correspond to the fixtures described in FIG. 1 and FIG. 2. Furthermore, the framework-like reinforcement struts 21 are shown.

FIG. 4 shows a floor plan of a larger mobile facility for dairy cattle with six running gears 1, walking areas 3, and a plurality of entries and exits 7. The walking areas 3 can be driven on here. The recovery areas 4 are configured as resting pens 12. 18 resting pens 12 of this type are shown overall in this exemplary embodiment, the number of which can be increased by a total of 4 if needed by the use of the mobile separating devices for variable functional regions 9, plug-in walls in this case. Since dairy cattle herds are hierarchically structured, further plug-in walls 9 for separating regions can also be used in order to prevent conflicts. Moreover, the plug-in walls 9 can also be used to separate birthing bays. The remaining designations correspond to those of FIGS. 1 to 3.

FIG. 5 shows the front view with respect to this with a detailed functional floor construction and an extended bogie 2, in this case the wheels 1. Here, the longitudinal beams 15, the transverse beams 16 and the lattice construction 17 are shown. Here, the functional floor lies on the supporting elements 18 which connect it to the meadow ground. If only small height differences are to be compensated for, lifting of the mobile facility before the movement can take place by variation of the tire pressure and the pressure of the supports.

FIG. 6 shows the same variant as FIG. 4 and represents the configuration and the construction of the functional floor; a further variant for dairy cattle which is suitable for a relatively large herd of cows. Here, occupancy of the functional floor with devices for dairy cattle is shown by way of example. The areas 3, 14 are designed with their supports as load-bearing supports for the walking and movement region and comprise, for example, concrete or wood. They can be driven on satisfactorily by small agricultural machines. The areas 4 have a load-bearing substructure as rest and recovery region made from metal, wood or concrete, and are equipped for instance with rubber mats, water mats, straw and sawdust as overlay. They are not normally driven on. The supports are mounted fixedly on the longitudinal beams 15 and the transverse beams 16, or are fixed by way of plug-in connections and at the same time serve for the torsional rigidity of the construction during transport.

Therefore, FIG. 6 shows a floor plan like the floor plan shown in FIG. 4 from the perspective of FIG. 5 with the same elements at the level of the load-bearing frame. Here, the longitudinal beams 15 are connected in a framework-like manner to the transverse beams 16 and form the supporting structure. In the region of the intersection points, the functional floor lies on the supports 18 which are mounted in a dimensionally fixed manner or else are height-adjustable. They are, for example, rolling bellows which are connected to a compressed air system; lifting cylinders are also possible here. The selection of suitable supports depends on the terrain contours and the requirement for height compensation. In the case of a correspondingly great height compensation by the supporting elements, a height-adjustable bogie 2 can be dispensed with. In the regions 3 in which vehicles can also drive, the longitudinal beams 15 are arranged at shorter spacings from one another.

FIG. 7 shows the side view. In comparison with the side view of the smaller design variant, more struts 19 and 21 are used, in order to correspondingly reinforce the stability without substantially increasing the weight.

FIG. 8 shows a further variant for livestock in general. Here, partition walls 9 are provided as lateral boundaries, in order to reserve individual regions 4 for special tasks. Otherwise, the animals can utilize the region 4 as desired; the region 3 can also be driven on here by simple vehicles. Furthermore, troughs 13 are provided.

FIG. 9 shows the front view. It can be seen here that the moving area 4 is designed to be inclined slightly and to slope toward the right. The gradient is approximately 6°. As a result, excrement runs off, indicated by the arrows, into the manure surface and manure removal area 3 and can be removed by bulldozers or pushers.

FIG. 10 shows the occupancy of the areas for horses in a floor plan. The areas 22 are occupied by stalls, wherein they can be communal stalls or individual stalls as required; the area 3 is a moving area. The area 24 serves as a care region, in which the horses can be cleaned and other cleaning work can take place; moreover, it serves as an animal husbandry region for employed people; the area 24 is secured by way of doors 25 which cannot be opened by the animals themselves in contrast to the entries and exits 7. The entrances 25 to the stalls are configured as sliding doors and are lockable. The troughs 13 are also shown. The areas 23 serve to collect feces and are covered with straw. Paths on which vehicles can drive are opened by opening the sliding doors 25, in order to remove the manure from the collecting points. Feeding regions 6 are also provided.

FIG. 11 shows the design variant for horses in the front view. Wind protection meshes 27 are arranged below the roof 20; in this way, fresh air can flow into the mobile facility without flies being able to fly in. Stalls with sliding doors 25 are provided in the left-hand region; and an entrance 7 which can also be used by horses is provided in the middle. To the right of this is a feeding region 6 which can be used by the animals both from the inside and from the outside, depending on the weather. An entrance 7 for staff is provided on the extreme right. The supporting frame is supported laterally by the side walls or supports 19, and lies on the load-bearing frame which lies on the supporting plates 18.

FIG. 12 shows a floor plan of a mobile facility which is assembled in a modular manner from four detachable facility modules 28 for public road use, wherein the mobile facility is divided into four longitudinal parts which each individually per se permit road transport. Each of these four parts has a dedicated hitch apparatus 8 and a bogie 2 with wheels 1, and in this way can be pulled by way of a conventional tractor to a different meadow area.

The individual modules are separated at the detachable module connections 29. These hold the individual modules together in the non-disassembled state. The mobile separating devices 9 form the partitions for the animals, and form the boundaries for transport in the disassembled state, in order that the animals can travel therein. The remaining designations correspond to the preceding figures. The upper part of FIG. 12 shows two facility modules 28 which have already been separated completely from one another, and the lower region shows two facility modules 28 shortly before they are disconnected for subsequent transport.

FIG. 13 shows the mobile facility from FIG. 12 from the front view, that is to say from the view of the tractor unit, wherein the detachable module connections 29 with a height compensating joint are also shown, which can be required if the pasture ground for erection has unevennesses. The two facility modules 28 shown on the left-hand side are already separated from one another and are situated at different heights on uneven ground; the two facility modules 28 shown on the right-hand side are still connected to one another, wherein the module connections 29 can be released despite the slope.

In the assembled state, the height-variable supporting elements 18 bring about a height compensation, but these supporting elements 18 are retracted before transport and the individual facility module 28 lies solely on its wheels 1 of the bogie 2, wherein the trailer loads on the hitch apparatuses 8 are kept as low as possible, which can be brought about by trimming in accordance with known methods.

The collapsible roof overhang 30 is also shown, which is collapsible in order that the maximum permissible width during transport is not exceeded. Depending on the conditions of the route for transport, the roof 20 can also be of collapsible design, in order that height restrictions can also reliably be adhered to, for instance when driving under bridges or at traffic lights.

FIG. 14 shows a floor plan of relatively large facility combinations 31, the modules of which, although they are not suitable for road transport, can be pulled over large free areas. Here, the individual modules are configured in their full width, but are divided in terms of their length. In order to enable navigation, the bogies 2 are configured as a steering system 32 (these are self-steering axles or positive steering systems as a rule), as a result of which they can be steered and can also travel around bends. Depending on the towing forces to be applied, the individual modules can also be coupled via the hitch apparatuses 8, and transport can take place jointly. The required towing forces can be generated by tow ropes and fixedly installed hydraulic winches, wherein satisfactory anchoring is to be ensured.

It goes without saying that the divisions which are shown in FIGS. 12 to 14 can also be combined with one another, with the result that the modules have both transverse and longitudinal divisions.

### DEFINITION OF TERMS

Abstractions and concrete specifications are used, partially with the same designations:
The abstraction “running gear” is understood to mean the concrete specifications “tire running gear” and “wheels”; a railborne bogie or a track running gear would likewise be a “running gear”.
“Areas” is the abstraction and “regions” are concrete specifications which are differentiated from mere areas in that they can be divided; the remaining concrete specifications are specific uses for areas or regions, wherein the designation 3 represents areas which can be driven on and the designation 4 represents areas which cannot be driven on.
“Entrance” is the abstraction and “entry and exit” is the concrete specification if an entrance is to be possible in both directions; otherwise, it is only one of the terms “entry” or “exit” if the entrance is to take place only in one direction. The plural is used if the designation is to apply by way of example to a plurality of entrances.
“Functional floor” is the abstraction, and “framework”, “longitudinal beam” and “transverse beam” are exemplary concrete specifications, from which the functional floor can be formed, but does not necessarily have to be formed.
“Supporting elements” is the abstraction, and “supports” and “supporting plates” are concrete specifications.
“Separating devices” is the abstraction, and “mobile separating devices”, “lateral boundaries”, “struts”, “partition walls” and “side walls or supports” are concrete specifications which are each per se separating devices with specific functions.

### LIST OF DESIGNATIONS

1 Running gear, tire running gear, wheels
2 Chassis/bogie
3 Walking, moving and active area/manure surface and manure removal area
4 Rest, bed and recovery area
5 Milking device
6 Feeding region
7 Entry and exit, entrance
8 Hitch apparatus
9 Mobile separating device for variable functional regions, partition walls
10 Separation region
11 Plug-in board
12 Resting pens
13 Trough
14 Floor reinforcement for vehicles and machines
15 Longitudinal beam
16 Transverse beam
17 Lattice construction
18 Supporting elements
19 Side boundaries, supports, struts
20 Roof
21 Reinforcement struts
22 Individual and group pens
23 Waste collecting point
24 Care and cleaning region
25 Entrances
26 Window
27 Wind protection mesh
28 Detachable equipment modules for public road operation
29 Detachable module connection with height leveling joint
30 Collapsible roof overhang
31 Equipment combination
32 Steering system

1. A mobile facility for livestock, comprising:
at least one base area with a floor,
at least four stable lateral boundaries,
a roof which covers at least the entire base area,
a frame,
a chassis with at least one bogie which is fastened to the frame,
at least one apparatus for initiating towing operation or propulsion operation or by self-propelling operation or as partial drive or as auxiliary drive,
a brake system.
wherein
the base area is formed by a functional floor,
wherein the functional floor is connected to the frame, or a supporting structure of the functional floor is configured as a frame,
the functional floor can be divided or is split into functional regions by way of fixed and/or lockable and mobile separating devices and, for this purpose, a multiplicity of receptacles for plug-in modules are provided in the functional floor,
at least one walking area for animals and staff, which can also be driven on by machines and vehicles, is arranged on the functional floor,
at least one rest surface for animals is configured on the functional floor,
a plurality of variable entries and exits with suitability for unassisted access are configured on the functional floor for the animals,
at least one entranceway for vehicles and at least one entrance for staff is provided on the functional floor.

2. The mobile facility as claimed in claim 1, wherein plug-in profiles with fitting means and releasable locking means are provided as mobile separating devices.

3. The mobile facility as claimed in claim 2, wherein walls, grids, gates, rods, fence elements and boards are provided as fixed and/or mobile separating devices.

4. The mobile facility as claimed in claim 1, wherein at least one hoisting/lifting/lowering apparatus is provided, by way of which the entire mobile facility can be lifted or lowered or stabilized.

5. The mobile facility as claimed in claim 1, wherein a multiplicity of height-adjustable or fixed supporting elements are provided, by way of which the entire mobile facility can be adjusted in terms of height, stabilized and oriented.

6. The mobile facility as claimed in claim 1, wherein the supporting structure of the functional floor is configured as a framework including grid constructions comprising flat, open and closed profiles or comprising solid profiles.

7. The mobile facility as claimed in claim 1, wherein at least one bogie is a tire running gear or a track running gear, and this at least one bogie is arranged between the frame/undercarriage and the functional floor or below an upper floor or outside the area of the functional floor.

8. The mobile facility as claimed in claim 1, wherein at least one hitch apparatus suitable for moving, for vehicles or at least one auxiliary drive or partial drive for assisting a tractor unit or at least one apparatus suitable for moving by hoisting winches or hydraulics or at least one drive suitable for self-propelled driving is provided on the frame.

9. The mobile facility as claimed in claim 1, wherein at least one apparatus for steering or an independent steering device or a self-steering system or a positive steering system is provided on the frame.

10. The mobile facility as claimed in claim 1, wherein lockable longitudinal and/or transverse beams are provided on the frame.

11. The mobile facility as claimed in claim 1, wherein it is designed such that it can be separated into modules.

12. The mobile facility as claimed in claim 11, wherein the frame is of detachable, separable, collapsible, foldable, telescoping or retractable configuration such that it can be reduced to a road width.

13. The mobile facility as claimed in claim 11, wherein the mobile facility is combined module by module behind one another and/or next to one another.

14. The mobile facility as claimed in claim 1, wherein at least one of the following facilities is provided:
active, eating, playing, care and activity zones,
medical, birth and baby region,
individual and communal regions,
bedding regions for straw, pellets and sawdust or the like,
a waste receiving and collecting point,
a wastewater collecting apparatus with a urine and dung collecting container or tank,
mechanical or automated manure removal of the manure surface and bedding regions,
the water and fodder supply, for instance by storage capacities, stocks, or by lines and/or hoses which can be connected separately to supply lines, or at/by supply points or supply carriages,
a milking device, shearing facility, riding, cleaning and care facility,
a solar roof for the power supply of operational devices,
a climate control system including heating and cooling with insulated floor, wall and roof elements such as, for example, panels,
a draft-free ventilation system,
an exhaust air filter for pollutants,
a rainwater retention and collection system for providing cleaning water,
a catching apparatus for animals,
space for office, lounge, cheese production, butchery, meat processing,
facilities for cleaning, maintenance, repair and disinfection,
protective devices against predators.
protection against sunlight, wind and drafts, rain and snow,
insect protection,
adequate daylight and lighting.

15. A method for configuring an apparatus as claimed in claim 1, for species-appropriate farming of livestock, wherein plug-in modules are locked in receptacles of the functional floor for the design and separation of functional regions, wherein the plug-in modules are
plug-in walls,
plug-in boards,
sliding doors,
troughs,
feeding devices.

16. The method as claimed in claim 15 for species-appropriate farming of livestock, wherein the functional regions
recovery and rest areas,
walking and moving areas
birthing bays
are formed by locking mobile separating devices into the receptacles of the functional floor.
